(19) United States
(12) Patent Application Publication
(10) Pub. No.: US 2009/0307026 A1
(43) Pub. Date: Dec. 10, 2009

(54) PRIORITY-BASED SYSTEM FOR NETTING AVAILABLE COVERAGE

(75) Inventors: Thomas R. Ervolina, Poughquag, NY (US); Michael T. Geroulo, Plattsburgh, NY (US); David J. Gravel, Newburgh, NY (US); Richard J. Lukes, Denver, NC (US)

Correspondence Address: IBM Washington - Nelson and Nelson, 2984 E. Evergreen Ave., Salt Lake City, UT, 84109, US

(73) Assignee: International Business Machines Corporation, Armonk, NY (US)

(21) Appl. No.: 12/136,647

(22) Filed: Jun. 10, 2008

(51) Int. Cl. G06Q 10/00

(52) U.S. Cl. 705/7

(57) ABSTRACT

A method is disclosed in one embodiment of the invention as including receiving standard MRP input data, including supply rules. Demand priority data may also be received to provide a business ranking of the independent demands. The MRP input data and demand priority data may be transformed into a format usable by an implosion engine and a pegging solver. Such transformation may include providing artificial MRP input data for each of the components. The transformed MRP input data may be processed with the implosion engine and the pegging solver to provide pegged implosion data. A pegged supply shortfall for a component may then be calculated based on the pegged implosion data. Specifically, consumption of an artificial component may represent a supply shortfall for the component. The demand priority data for the independent demand that pegs to the supply shortfall may provide the prioritized shortfall for that component.

### BACKGROUND OF THE INVENTION

1. Field of the Invention

This invention relates to manufacturing planning and inventory control systems, and more particularly to systems and methods for netting manufacturing resources among competing demands based on business priority rules.

2. Description of the Related Art

Material Requirements Planning (“MRP”) and Manufacturing Resource Planning (“MRP II”) systems have been widely implemented in manufacturing industries to facilitate decision making and increase production line efficiencies.

Such systems are configured to optimize production planning by identifying component materials needed to produce an independent end product, the quantity of component materials needed to produce the end product, and the timing for ordering such component materials to meet end product demands. In some systems, production planning may be further optimized by assigning a priority to each end product.

In known production planning systems, however, priorities assigned to end products are typically considered only as a final step in the material allocation process. Indeed, available component materials are often distributed evenly or proportionally between end products early in the production process, without regard to the priority assigned to each. This may ultimately result in a component material shortage for certain high priority end products. Orders for additional component materials must then be expedited to meet immediate high priority production requirements.

Costs associated with expedited orders can be significant. Additional expenditures may be required, for example, to expedite manufacture of component materials at the supplier, or to engage the services of another supplier if the regular supplier is unable to fill the order under expedited conditions. Similarly, substitute materials may be required to fill orders that could have been satisfied by less expensive materials under non-expedited circumstances.

In view of the foregoing, what are needed are systems and methods for netting coverage at each stage of a production process based on a priority assigned to the end product. Beneficially, such systems and methods would provide consistent, repeatable, accurate, and timely prioritized shortfall data, and would be compatible with existing implosion engines and pegging solvers. Such systems and methods are described and claimed herein.

### SUMMARY OF THE INVENTION

The invention has been developed in response to the present state of the art and, in particular, in response to the problems and needs in the art that have not yet been fully solved by currently available systems and methods for netting coverage in a Material Requirements Planning (“MRP”) environment. Accordingly, the invention has been developed to provide improved systems and methods for netting coverage in an MRP environment based on priorities assigned to independent demands. The features and advantages of the invention will become more fully apparent from the following description and appended claims, or may be learned by practice of the invention as set forth hereinafter.

Consistent with the foregoing, a method is disclosed in one embodiment of the invention as including receiving standard MRP input data. Standard MRP input data may include, for example, independent demands, components, component bills of material, component coverage, and component lead time parameters. Demand priority data may also be received to provide a business ranking of the independent demands.

The MRP input data and the demand priority data may be transformed into a format usable by an implosion engine and a pegging solver. Such transformation may include providing artificial MRP input data for each of the components. Artificial MRP input data may include, for example, artificial components, artificial component bills of material, artificial component coverage, and artificial lead time parameters.

The transformed MRP input data may be processed with the implosion engine and the pegging solver to provide pegged implosion data. A pegged supply shortfall for a component may then be calculated based on the pegged implosion data. Specifically, consumption of an artificial component may represent a supply shortfall for the component. The demand priority data for the independent demand that pegs to the supply shortfall may provide the prioritized shortfall for that component.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram illustrating an exemplary production plan hierarchy in a Materials Requirements Planning (“MRP”) environment;

FIG. 2 illustrates one example of a system for determining and prioritizing component shortfalls in an MRP environment in accordance with the present invention;

FIG. 3 is a schematic diagram of an exemplary production plan hierarchy having standard MRP input data; and

FIG. 4 is a schematic diagram of the production plan hierarchy of FIG. 3 that includes MRP input data and attributes adjusted as needed to provide prioritized shortfall data in accordance with certain embodiments of the present invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the invention, as claimed, but is merely representative of selected embodiments of the invention.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose of the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

As used herein, the term “Material Requirements Planning” or “MRP” refers broadly to information integration business process strategies, including systems and methods for Material Requirements Planning, Enterprise Resource Planning, and/or Manufacturing Resource Planning. The term “independent demand,” or simply “demand,” refers to demand for an end product, assembly, sub-assembly or component (collectively referred to hereinafter as a “part”), which is unrelated to the demand for other parts. The term “coverage” refers to a quantity of available supply of a part. Coverage may include inventory supply, works-in-process, and/or works-in-transit.

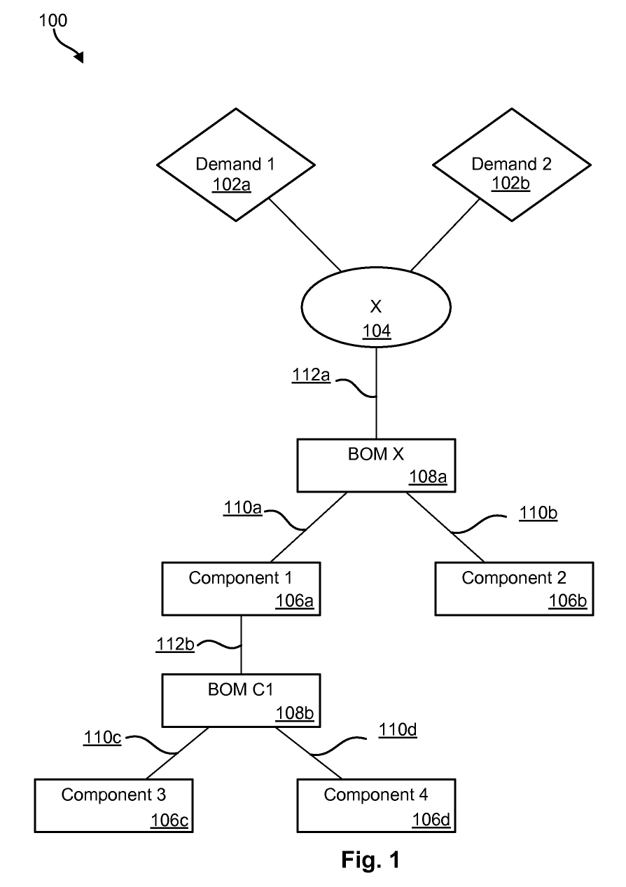

Referring now to FIG. 1, a production plan hierarchy 100 in a Material Requirements Planning (“MRP”) environment generally includes one or more independent demands 102 driving production of an end product 104. Independent demands 102 attached to the end product 104 may specify a quantity of end product 104 needed within a particular period of time, and may be characterized by one or more attributes such as customer, demand type, geographical location of customer, part class, and the like.

As depicted by FIG. 1, for example, multiple independent demands 102 may drive production of the end product 104. A first independent demand 102a may be characterized as backlog demand, or actual demand for the end product 104. A second independent demand 102b may be characterized as forecast demand. Forecast demand may be based on historical demand for the end product 104 during a particular period of time, or may be based on any other relevant factors known to those in the art.

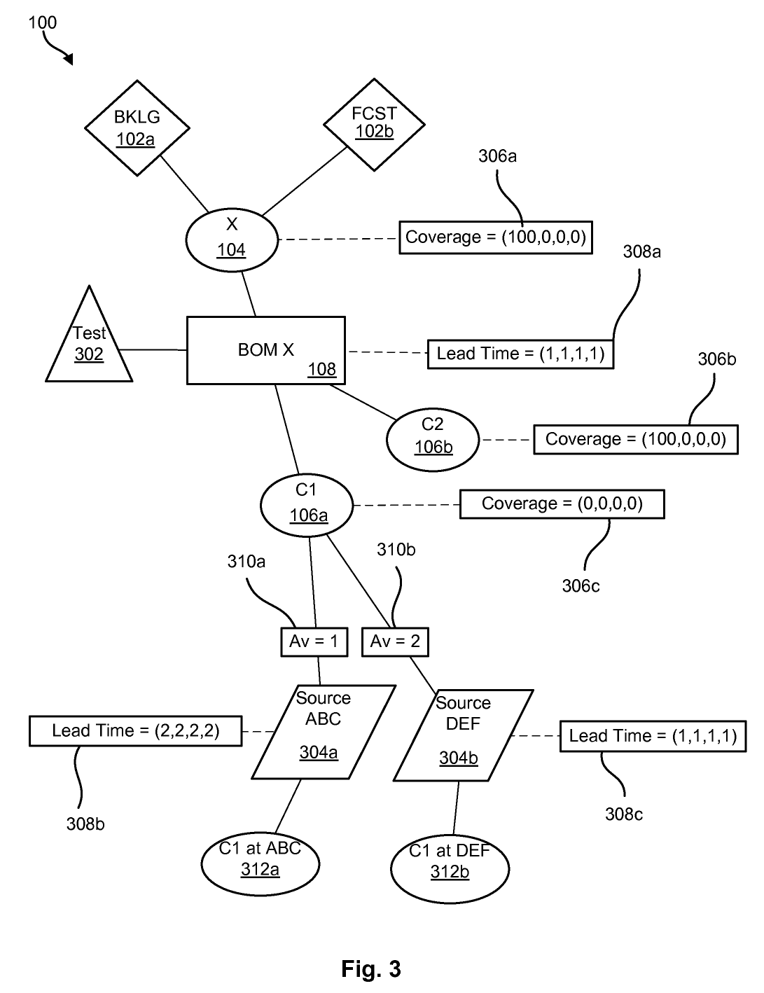

Production of an end product 104 in quantities sufficient to meet each independent demand 102a, 102b requires sufficient production and procurement of constituent sub-assemblies and/or components 106a-d within a scheduled period of time. As discussed in more detail with reference to FIG. 3 below, traditional MRP systems 100 operate in part to anticipate shortfalls in component 106 coverage, and thereby facilitate production of an end product 104 in quantities and within a period of time that is sufficient to meet demand.

Assembly of certain components 106c, 106d may be required to produce sub-assemblies 106a and other parts integral to the end product 104. Such components 106c, 106d may be assembled during an assembly operation 108, also known as a bill of materials for the part thereby produced. Diagrammatically, a bill of production arc 112 may connect the assembly operation 108 to the part thereby produced. Similarly, a bill of materials arc 110 may connect the assembly operation 108 to the components 106 required for assembly.

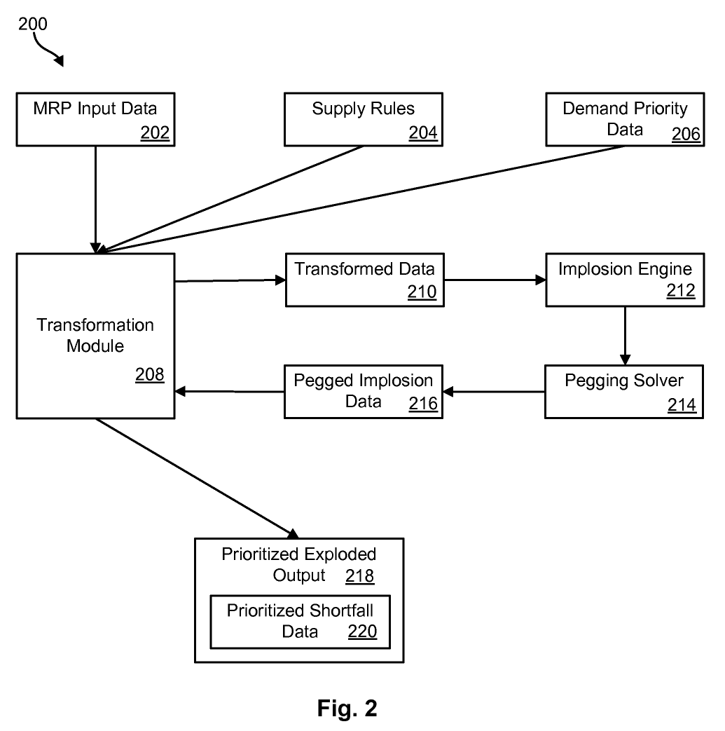

Referring now to FIG. 2, a system 200 for determining and prioritizing component 106 shortfalls in an MRP environment in accordance with the present invention may include a transformation module 208 configured to receive standard MRP input data 202, supply rules 204, and demand priority data 206. Standard MRP input data 202 may include, for example, information associated with independent demands 102, components 106, component bills of material 108, coverage, and lead time parameters. In some embodiments, standard MRP input data 202 may further include component transit times or component sourcing parameters.

Supply rules 204 may include netting rules and priority rules customized to maximize business efficiencies, and may be implemented to affect any level in the production plan hierarchy, as depicted in FIG. 1.

In some embodiments, supply rules 204 define multiple sources of supply. Sources of supply may include, for example, inter-plant suppliers, external suppliers, build-in-house supply, substitute parts, alternate parts, co-product generation, and any other sources of supply known to those in the art. Supply rules 204 may assign a priority to each of the multiple sources of supply to order utilization of such sources according to customer needs, economic efficiencies, demand types, time horizons, and/or any other relevant business considerations.

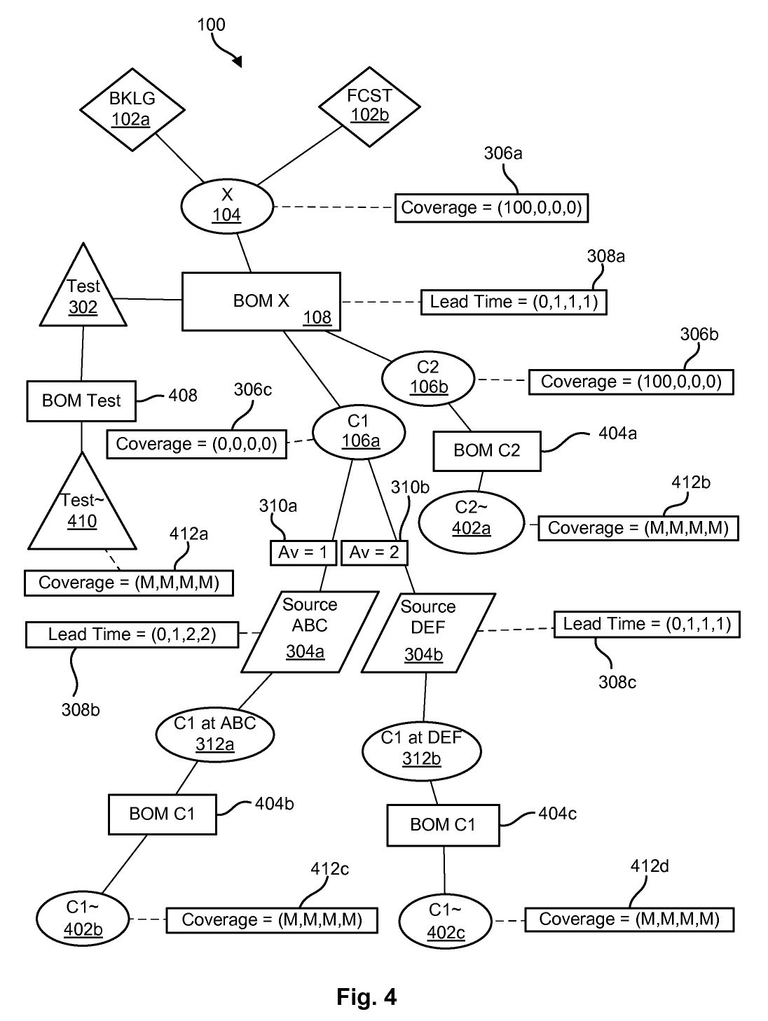

Supply rules 204 may further control a netting sequence across multiple sources of supply, or specify a proportional split target such that each supplier supplies a predetermined proportion of coverage for a part. In some embodiments, supply rules 204 may further provide an explode sequence when multiple sources of supply are further explodable, as discussed in more detail with reference to FIG. 4 below.

The transformation module 208 may also receive demand priority data 206 to provide a business ranking of the independent demands 102. Demand priority data 206 may be formulated according to any process or method known to those in the art. In some embodiments, demand priority data 206 may be predetermined by a priority manager or other device or system known to those in the art.

In certain embodiments, demand priority data 206 includes provisions for fair-sharing. In such cases, the demand priority data 206 may mandate that a shortfall in coverage affecting more than one independent demand 102 with the same priority be spread substantially evenly across the demands 102. In other embodiments, demand priority data 206 may define multiple demand 102 attributes, and may have flexibility to assign priorities at any level of aggregation in the production plan hierarchy 100 based on the demand 102 attributes.

The transformation module 208 of the present invention may transform the standard MRP input data 202, the supply rules 204, and the demand priority data 206 (collectively, the “input data”) into a format usable by an implosion engine 212 and a pegging solver 214. As described in more detail with reference to FIG. 4 below, the transformation module 208 may transform the input data into transformed data 210 that incorporates characteristics of both an unconstrained MRP supply chain planning problem and a constraint-based implosion problem.

The transformed data 210 may then be processed by an implosion engine 212 and a pegging solver 214 to provide pegged implosion data 216. The implosion engine 212 may operate in the conventional manner to allocate components 106 to end products 104 in accordance with the demand priority data 206. Specifically, the implosion engine 212 may use its optimization logic to ensure that the independent demands 102 are satisfied in the prioritized order specified by the demand priority data 206, while simultaneously ensuring that parts are consumed and exploded in sequence according to the supply rules 204.

The pegging solver 214 may then assign all the actions in the production plan hierarchy 100 to the top-level independent demands 102 that drove the actions. Actions may include, for example, consumption of parts and capacity, as well as execution of operations for production, assembly, interplant, co-product generation, substitution, and any other actions known to those in the art.

In some embodiments, the pegging solver 214 may be integrated within the implosion engine 212 such that it may build a pegging schedule concurrently while the implosion engine 212 makes allocation decisions. Alternatively, the pegging solver 214 may utilize the unpegged output of the implosion engine 212 to calculate optimal pegging assignments based on the demand priority data 206 and supply rules 204.

In any case, the implosion engine 212 and pegging solver 214 may be implemented as an integrated, single stage allocation process or as a two stage allocation process, where the implosion engine 212 determines consumption and volumes, and the pegging solver 214 allocates consumption to the independent demands 102.

The transformation module 208 may merge the output of the implosion engine 212 and the pegging solver 214 to create prioritized, exploded output 218 in a format which resembles traditional MRP output, as is known to those in the art, with added pegging functionality. Further, unlike the prior art, the prioritized, exploded output 218 of the present invention may be based on supply rules 204 and demand priority data 206 such that consumption and actions are substantially intelligently allocated to the independent demands 102 driving production. As discussed in more detail with reference to FIG. 4 below, the prioritized, exploded output 218 of the present invention may include prioritized shortfall data 220. This additional data 220 may enable intelligent and strategic decision making regarding procuring and expediting parts needed to meet high priority demands 102.

Referring now to FIG. 3, an exemplary production plan hierarchy 100 may include an end product 104 having coverage 306a of one hundred units in the first week, zero in the second week, zero in the third week, and zero in the fourth week, for example. Production of the end product 104 may be driven by multiple independent demands 102a, 102b. A first independent demand 102a may be characterized as backlog demand, or actual demand for the end product 104. A second independent demand 102b may be forecast demand for the end product 104, as discussed above with reference to FIG. 1.

An assembly operation 108 for the end product 104 may have a lead time of one week in the first week, one week in the second week, one week in the third week, and one week in the fourth week. The assembly operation 108 may require multiple components 106a, 106b. A first component 106a may have coverage 306c of zero in the first week, zero in the second week, zero in the third week, and zero in the fourth week. A second component 106b may have coverage 306b of one hundred in the first week, zero in the second week, zero in the third week, and zero in the fourth week. The assembly operation 108 may further have a finite test capacity 302.

Multiple sources 304 may be used to procure a component 106 or other part. In the present example, the first component 106a required for the assembly operation 108 may be acquired from either of two sources 304a, 304b. The first source 304a may have a lead time 308b of two weeks in the first week, two weeks in the second week, two weeks in the third week, and two weeks in the fourth week. The second source 304b may have a lead time 308c of one week for each of the four weeks.

Despite the longer lead times 308b, however, the first source 304a may be preferred over the second source 304b. Accordingly, a supply rule 204 may require that the first source 304a be tapped to procure as much coverage 306c as possible of the component 106a before moving on to the second source 304b. An aversion attribute 310a of one may thus be assigned to the first source 304a, while the second source 304b may be assigned an aversion attribute 310b of two.

Referring now to FIG. 4, the present invention may require modification and/or addition of certain attributes and parts to render the MRP input data 202, supply rules 204, and demand priority data 206 compatible with existing implosion engines 212 and pegging solvers 214. As discussed above with reference to FIG. 2, for example, such modifications, additions, and other transformations may be implemented by a transformation module 208, or by any other device or method known to those in the art.

As shown in FIG. 3, for example, lead times 308a associated with the assembly operation 108 for the end product 104 are one week in each of the four weeks. Accordingly, to have coverage 306c of one hundred units of the end product 104 in week one, the assembly operation 108 would need to begin a week prior. This creates an infeasible situation that renders the standard MRP input data 202 incompatible with a constraint-based implosion engine 212.

To avoid this result, lead times 308 may be adjusted such that lead times 308 in week one are zero. Lead times 308 in successive weeks may be adjusted as needed to ensure adequate coverage 306 of the parts produced by the respective assembly and sourcing operations 108, 304 in each week.

Similarly, existing implosion engines 212 require at least one unconstrained path with respect to both capacity and supply. Embodiments of the present invention may create a dummy structure of artificial operations 404, 408 and parts 402, 410 to effectively neutralize the constraints characteristic of standard MRP input data 202.

For example, artificial supply 402a, 402b, 402c of components 106a, 106b with infinite coverage 412b, 412c, 412d (represented by the letter “M”) may be created to effectively remove component 106a, 106b supply constraints. Likewise, artificial capacity 410 with infinite coverage 412a (also represented by the letter “M”) may be created to remove capacity 302 constraints. Associated artificial assembly and sourcing operations 404, 408 may be created to link the artificial supply and capacity 402, 410 to their respective true sources of supply 312a, 312b and capacity 302.

In some embodiments, the present invention may incorporate supply rules 204 to manage multiple sources of supply 304a, 304b, where each supply source 304a, 304b includes an artificial, infinite supply 402b, 402c in addition to true, finite supply 312a, 312b. Particularly, supply rule 204 logic may create an explode sequence such that artificial sources of supply 404b, 404c may not be tapped until coverage 306 has first been net from true sources of supply 312a, 312b.

For example, coverage 306c may net first from a first supply source 304a having an aversion attribute 310a of one. If there is insufficient true supply 312a at the first supply source 304a, coverage 306c may then net from a second supply source 304b having an aversion attribute 310b of two. If there is insufficient true supply 312b at the second supply source 304b, coverage 306c may then net from the first artificial supply source 402b, and then from the second artificial supply source 402c. Netting order of artificial supply sources 402b, 402c may be pre-determined according to supply rule 204 logic.

In this manner, artificial sources of supply 402a, 402b, 402c and capacity 410 may be tapped to provide artificial coverage 412 wherever a shortfall in true supply 312a, 312b or capacity 302 exists. The amount of the shortfall in true supply 312a, 312b or capacity 302 may be easily determined by referencing the amount consumed of the artificial sources of supply 402a, 402b, 402c and capacity 410. Because the shortfall equates to the amount of artificial sources of supply 402a, 402b, 402c and capacity 410 consumed, the pegging solver 214 may easily peg the shortfall to the demand 102 driving it. This information may facilitate intelligent decision making regarding a need to expedite or order additional parts or procure additional capacity 302.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for determining and prioritizing component shortfalls in a Material Requirements Planning (“MRP”) environment, the method comprising:
receiving, by a computer, standard MRP input data comprising independent demands, and a true supply of components;
receiving, by a computer, demand priority data to provide a business ranking of the independent demands;
transforming, by a computer, the MRP input data by adding an artificial supply of components to the true supply of components to remove component supply constraints for the independent demands;
processing, by a computer, the transformed MRP input data and the demand priority data with an implosion engine and a pegging solver to provide pegged implosion data, wherein the implosion engine consumes the true supply of components prior to consuming the artificial supply of components,
calculating, by a computer, a pegged supply shortfall for at least one of the components, wherein consumption of a component in the artificial supply equates to a supply shortfall for the component, and wherein the demand priority data for the independent demand that pegs to the supply shortfall determines a prioritized shortfall for the component.
